(19) United States
(12) Patent Application Publication
(10) Pub. No.: US 2018/0103814 A1
(43) Pub. Date: Apr. 19, 2018

(54) Adaptable Vacuum Unit With Adjustable Debris Can Egress

(71) Applicant: James Roger Harman, Gig Harbor, WA (US)

(72) Inventor: James Roger Harman, Gig Harbor, WA (US)

(21) Appl. No.: 15/845,789

(22) Filed: Dec. 18, 2017

Related U.S. Application Data
(60) Provisional application No. 61/851,777, filed on Mar. 13, 2013.
(60) Provisional application No. 62/563,628, filed on Sep. 26, 2017.

(51) Int. Cl. A47L 9/12; A47L 9/10; B01D 46/02

(52) U.S. Cl. CPC A47L 9/12; B01D 2273/28; B01D 46/02; A47L 9/104

(57) ABSTRACT

An adaptable vacuum cleaning unit featuring adjustable debris can egress direction, a filter canister assembly having multiple canister doors and vacuum inlet ports, a canister mounted vacuum producer, and a debris can lifting and locking bar. The vacuum cleaning unit separator assembly includes a separator filter canister assembly mounted to a rotatable base assembly having a debris can, whereby rotation of attachment of the base assembly to the filter canister assembly allows the orientation of the debris can to be rotated relative to the position of the separator filter canister assembly. The casing of the separator filter canister assembly has multiple access doors and vacuum inlets. The vacuum cleaning unit further features lifting lugs around the top edge of the filter canister assembly and forklift slots in the base of the unit. The adaptable vacuum unit also includes an adjustable speed vacuum producer that permits control of the rate of air flow.

This application claims the benefit of U.S. Provisional Application No. 61/851,777 filed Dec. 18, 2016 and U.S. Provisional Application No. 62/563,628, filed Sep. 26, 2017.

### FIELD OF THE INVENTION

The present invention relates, generally, to industrial and commercial vacuum cleaning systems or units. More particularly, the invention relates to an industrial vacuum unit that allows on site configuration in applications where installation of a traditional vacuum unit may not be feasible.

### BACKGROUND

An exemplary industrial or commercial vacuum cleaning system that employs a separator and filter canister assembly having a removable debris can and a vacuum producer connected to the separator for evacuating air from it is illustrated and described in U.S. Pat. No. 4,874,410. The tubular bag separator disclosed therein includes a cylindrical casing that houses a bag chamber containing inverted filter bags mounted to a moveable bag head which comprises a manually or powered operable bag shaker mechanism. Access to the bag chamber is provided by a single access door on the front of the housing. Installation of the vacuum cleaning system requires positioning the system in an orientation that allows access to the single access door for servicing the filter bags in the canister.

A debris can is contained within a base assembly and cooperates with the casing to form a lower portion of the separator. The debris can has a rim flange which cooperates with a pivotally moveable bail or other mechanism for lifting the debris can into and retaining it in sealing engagement with the lower end portion of the separator casing. In this configuration, the debris can may be readily detached from the separator casing and removed from the base assembly to allow removal of debris from the debris can. The base assembly typically has an opening on one side that defines the direction of egress of the debris can. The debris can is typically mounted on wheels to facilitate removal of the debris can.

In operation of the vacuum cleaning system, a vacuum producer draws air into the separator through a vacuum inlet. The vacuum air stream is directed toward one or more striker or deflector plates. An air tight plate with filter bag attachment ports separates the filter canister from the separator. Heavy or large debris particles carried by the vacuum air stream contact the striker plate(s) in the separator and drop into the debris can. The lighter debris not separated by contact with the striker plate(s) is carried by the air stream through the ports and into the attached inverted filter bags where most of it is trapped.

A typical industrial vacuum cleaning system as described above usually is effective at removing heavy or large debris from the vacuum air stream and depositing it into the debris can. The debris can in turn may be readily removed from the base assembly to allow accumulated debris to be disposed of from the debris can. The base assembly is typically permanently affixed in the vacuum cleaning system through welding or similarly permanently attaching the vacuum bag canister onto the top of the base assembly.

Accordingly, the direction of egress of the debris can from the base assembly is limited to a single direction from the base assembly. This single, permanent direction of debris can egress relative to the rest of the vacuum cleaning system can be a primary factor in limiting the positioning and placement of the vacuum cleaning system, since positioning and placement of the system must allow for access to and removal of the debris can. In this regard, positioning and placement of a vacuum cleaning system can be restricted, particularly in industrial applications in which there is limited or tight space for installation of a vacuum cleaning system.

In addition to allowing for debris can egress, position and placement of the system must allow for access to the bag chamber provided by the access door on the front of the housing, further contributing to restrictions on vacuum system placement. Typically, the debris can base and access door will face the same direction to allow for access, thereby limiting design of the system to account for placement of the debris can base and access door on the front of the housing.

Placement of a typical industrial vacuum cleaning system can be further compromised by the position of the vacuum producer. Typically, the vacuum producer is mounted on a base that connects to or is an extension of the debris can and canister base. The vacuum system accordingly has a relatively large or cumbersome installation area footprint to accommodate the separator and filter canister assembly along with the vacuum producer.

The physical installation of a typical industrial vacuum cleaning system can be impeded by the lack of lifting or handling features to assist in placing a vacuum system. Typically, a vacuum system is designed with respect to its final, operational location with little to no regard for lifting or handling features incorporated into the system to facilitate and ease installation.

In addition to positioning and placement limitations of a typical vacuum unit that can limit its adaptability for specific installations, many industrial and commercial vacuum producers are designed to run at one constant speed thereby limiting the ability to adjust the rate of air flow. Accordingly, vacuum unit adaptability can be enhanced by a vacuum unit that has a vacuum producer with a controller that allows for adjustable speed control to adjust air flow.

The typical industrial vacuum cleaning system can impose positioning and placement limitations of the vacuum unit, given the typical separator assembly of a single access door in a separator and filter canister, along with the removable debris can having a single, fixed orientation of egress from the base assembly. Moreover, positioning and placement can be limited by the size of the unit given the footprint of the canister and vacuum producer bases. Accordingly, there is a need for an adaptable vacuum cleaning system that allows for on site configuration where installation of a traditional vacuum unit is not readily feasible. In particular, there is a need for an adaptable vacuum system that incorporates an adjustable debris can egress direction, multiple canister assembly doors, multiple vacuum inlet ports, a canister assembly mounted vacuum producer, features that facilitate handling and installation of the vacuum system, and a vacuum producer with an adjustable rate of air flow. The present technology provides such a desirable vacuum cleaning unit having these features.

### SUMMARY OF THE INVENTION

A primary objective of the presently disclosed technology is to provide an adaptable vacuum cleaning system or unit having a separator assembly in which the filter canister assembly is attached to a rotatable base assembly having a debris can. The vacuum cleaning system advantageously incorporates an adjustable debris can direction of egress; a debris can lifting and locking bar; multiple filter canister access doors; multiple vacuum inlet ports; a canister mounted vacuum producer; lifting lugs around the top edge of the canister assembly; slots in the base of the unit to facilitate handling the unit with a forklift, and an adjustable speed vacuum producer that permits control of air flow rate.

The debris can is removably attached to the base assembly by a lifting, sealing, and locking mechanism. The base assembly contains an opening that defines the direction of egress of the debris can from the base assembly. By allowing rotation of the attachment of the filter canister assembly to the base assembly, the base assembly can be rotated relative to the filter canister assembly. The ability to rotate the base assembly provides different positions of the opening of the base assembly and corresponding different orientations of the direction of egress of the debris can. The ability to reorient the direction of the egress of the debris can at the installation site provides for enhanced versatility of installation locations for the vacuum cleaning unit.

In addition to providing different orientations of egress of the debris can, the installation versatility of the presently disclosed vacuum cleaning unit is further increased by including two or more access doors and two or more vacuum inlets to the filter canister assembly. Multiple access doors increase the versatility of the installation location or placement of the vacuum cleaning unit, since access to one of the access doors can be limited or blocked due to space constraints of particular installation sites Likewise, multiple vacuum inlets increase the versatility of installation location by providing multiple sites to which vacuum tubing can be attached. If only one vacuum inlet is being used, the other vacuum inlets are sealed off.

Some of the objectives of the invention having been stated, other objectives will appear as the description proceeds when taken in connection with the accompanying drawings.

### BRIEF DESCRIPTION OF THE DRAWINGS

FIG. 1 is a schematic perspective view of an embodiment of the vacuum unit.

FIG. 2 is an exploded schematic perspective view of an embodiment of the vacuum unit showing a configuration of attachment of the filter canister assembly (with attached vacuum producer and electrical control enclosure) to the base assembly, including a ring seal disposed between the filter canister assembly and the base assembly.

FIG. 3 is a schematic perspective view of an embodiment of a vacuum unit similar to the vacuum unit shown in FIG. 1, in which the base assembly has been rotated 90 degrees clockwise relative to the filter canister assembly.

FIG. 4 is a schematic perspective view of an embodiment of a vacuum unit similar to the vacuum unit shown in FIG. 1, in which the base assembly has been rotated 180 degrees clockwise relative to the filter canister assembly.

FIG. 5 is a cut away view of an embodiment of a vacuum unit similar to the vacuum unit shown in FIG. 1

### DETAILED DESCRIPTION OF THE PREFERRED EMBODIMENTS

The overall configuration of a typical vacuum cleaning unit as described herein includes, but is not limited to, a separator assembly having a filter canister assembly, a vacuum producer mounted to or independently of the filter canister assembly, an electrical control enclosure, and a base assembly to which the filter canister assembly is mounted. The base assembly includes the removable debris can. The filter canister assembly includes an access door(s) to allow access to inverted filters contained in the filter canister assembly, as well as a vacuum inlet.

The presently disclosed adaptable vacuum unit design combines several features that allow for on-site configuration in applications where installation of a traditional vacuum unit is not feasible. It also includes adjustable performance parameters to match application requirements. These features include, but are not limited to, an adjustable debris can egress direction; multiple bag canister assembly doors; multiple vacuum inlet ports; a canister mounted vacuum producer; a debris can lifting and locking bar; lifting lugs placed around the top edge of the canister assembly; slots in the base of the unit that facilitate handling of the unit with a forklift; and an adjustable speed vacuum producer that permits control of air flow rate. The advantages of these features are detailed herein.

As described above, previously disclosed vacuum units that contain a removable debris can mounted below a filter canister assembly limit direction of egress of the debris can from the base assembly to a single direction. The presently disclosed adaptable vacuum unit allows the filter canister assembly to be mounted at different positions on the base assembly, thereby allowing the position of the base assembly to be rotated relative to the filter canister assembly. Rotation of the position of the base assembly in turn allows rotation of the direction of debris can egress, such that the adaptable vacuum unit allows for adjustable debris can egress direction. The multiple options for adjustable debris can egress direction allows the vacuum unit to be installed with optimum orientation in a specific installation environment without blocking removal of the debris can for emptying. The base assembly containing the debris can lift assembly can be rotated to a position at the site of vacuum unit installation that provides clearance for debris can removal and insertion. The direction of debris can egress can be adjusted before or at installation of the vacuum unit. Once the vacuum unit is installed with a specific orientation, the direction of debris can egress is set and not adjustable by an operator of the vacuum unit.

The debris can features a lifting and locking bar that allows the debris can to be unlocked from the bottom of the vacuum unit. The lifting bar rotates through a cam, allowing the debris can to be lowered from the base assembly until the castors on the bottom of the debris can contact the floor. The operator accordingly only has to support a fraction of the weight of the debris can. Likewise, the operator can readily lift and lock the debris can into place with the lifting and locking bar.

The adaptable vacuum unit described herein contains multiple bag canister doors on the filter canister assembly. The two or more canister doors enables the vacuum unit to be installed with an optimal orientation in a specific installation environment without blocking access for servicing the filter bags in the canister. This increased access allows for more flexible positioning of the vacuum unit, such that the vacuum unit can be positioned closer to a wall, other structure, or other equipment than a vacuum unit with a single canister door.

The configuration of installation flexibility afforded by the present adaptable vacuum unit is further enhanced by the presence of multiple vacuum inlet ports. The multiple ports provide for more direct tubing connections and connection options between overall vacuum system plumbing and the vacuum unit regardless of vacuum unit orientation. The increased tubing connection options results in less tubing, fewer plumbing elbows, and fewer other connection components required for connecting the vacuum unit to the rest of the overall vacuum system.

The presently disclosed vacuum unit preferably includes a canister assembly mounted vacuum producer, but may also be used with an independently mounted vacuum producer. The canister mounted vacuum producer decreases the foot print size of the vacuum unit, since the vacuum producer is supported by the canister and a portion of the base assembly, such that the vacuum producer does not require its own, separate base. In addition to increasing installation site flexibility, the canister mounted vacuum producer minimizes structural components required to support the vacuum producer. Furthermore, it minimizes plumbing and hardware components required to connect the vacuum producer to the canister, which in turn reduces overall weight of the vacuum unit.

The adaptability of the presently disclosed vacuum unit is further enhanced by a variable speed vacuum producer, which allows for adjustable air flow. Many industrial and commercial vacuum producers are designed to run at one constant speed, thereby limiting the ability to adjust air flow. In a preferred embodiment, the vacuum producer has unlimited speed control, within the design parameters of the vacuum unit, to adjust the rate of air flow. For example, the vacuum unit can be equipped with a three phase AC motor and variable frequency drive (VFD) controller. Adjustable rate of air flow, combined with the other vacuum unit features disclosed herein, increases the adaptability of the vacuum unit.

The adaptable vacuum unit described herein has multiple features that readily allow on site configuration of the vacuum unit in applications where installation of a traditional vacuum unit is not feasible. In addition, the adaptable vacuum unit has features that facilitate installation of the vacuum unit on site. The vacuum unit includes lifting lugs around the top edge of the canister that facilitate handling of the unit with an overhead lifting device. Furthermore, slots in the base of the unit facilitate handling the unit with a forklift. These two features minimize the equipment and manpower required to move the vacuum unit. Moreover, by easing the installation process, these features reduce the risk of damage to the vacuum unit from handling.

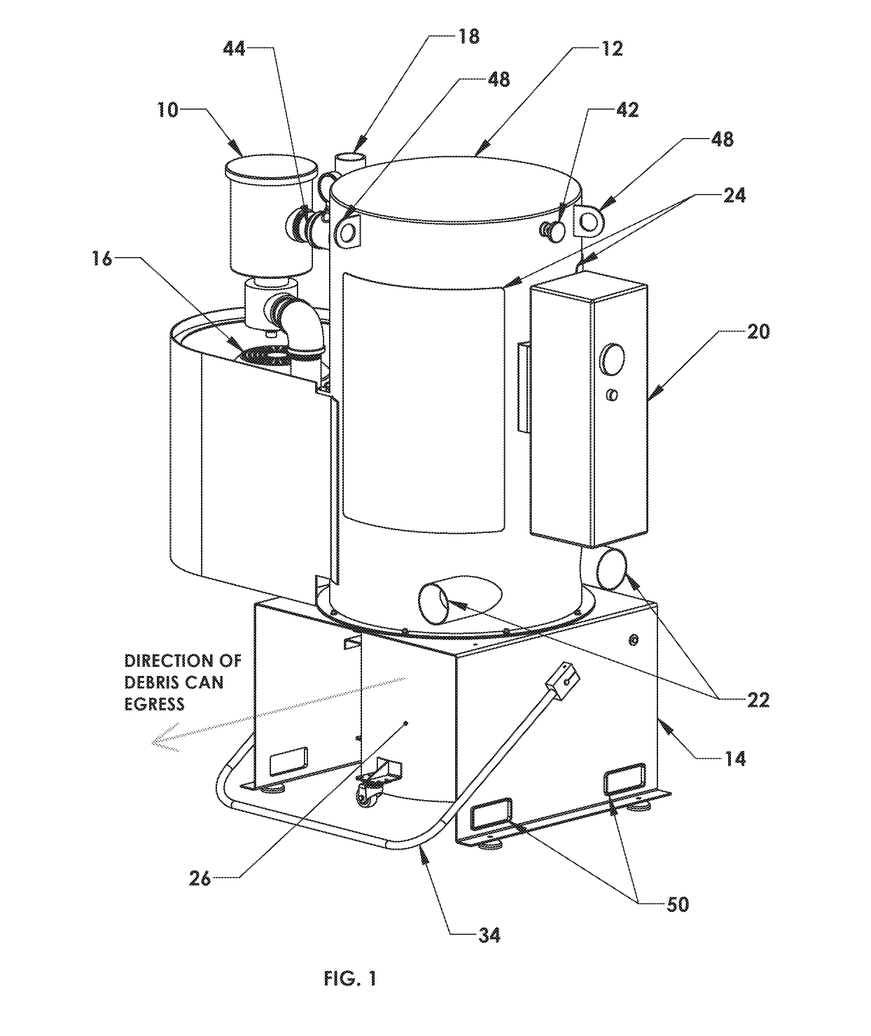

Turning now to the figures, the vacuum unit 10 shown in FIGS. 1-5 consists of a separator assembly having a filter canister assembly 12 attached to a base assembly 14. Attached to the filter canister assembly 12 is a vacuum producer 16 having an exhaust 18. An electrical control enclosure 20 is also attached to the filter canister assembly 12. The filter canister assembly 12 includes two vacuum inlets 22 and two access doors 24. The base assembly 14 includes a debris can 26 that has a direction of egress defined by an opening in the base assembly 14. As shown in FIG. 1, the vacuum unit may include lifting lugs 48 around the top edge of the canister assembly 12 and fork lift slots 50 in the base assembly 14 to ease and facilitate installation of the vacuum unit.

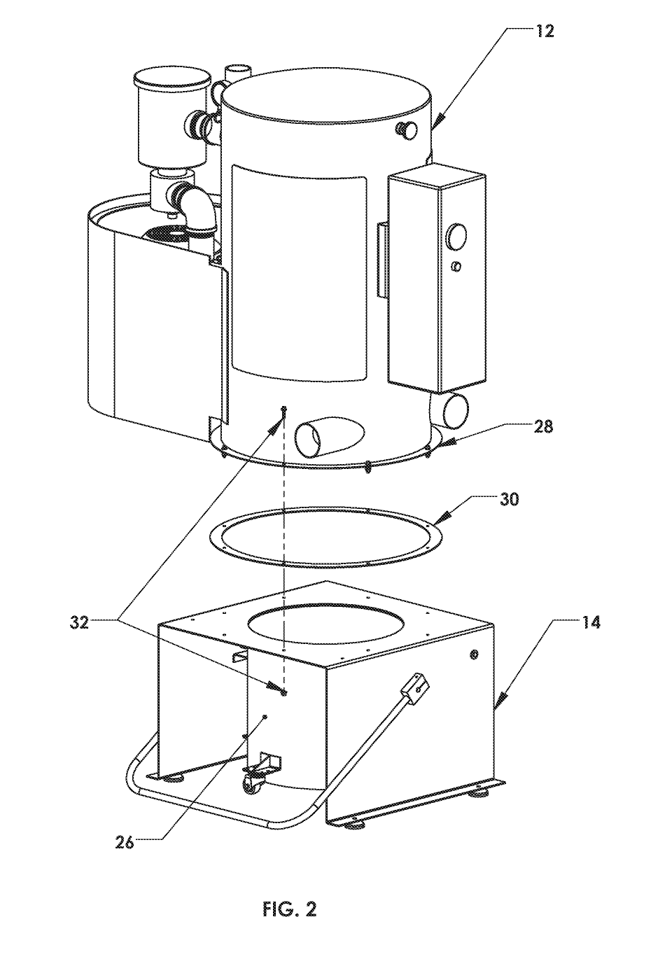

An embodiment of the vacuum unit 10 in which the separator assembly is removed from the base assembly 14 is shown in FIG. 2. In this embodiment, the filter canister assembly 12 attaches to the base assembly 14 by bolts that feed through holes in a flange 28 at the bottom of the filter canister assembly 12 into holes in the base assembly 14, whereby the bolts are held in place by washers and nuts. An elastomeric seal ring 30 is disposed between the flange 28 of the filter canister assembly 12 and the base assembly 14, and contains holes that align with those in the flange 28 and the base assembly 14. An exemplary bolt, washer, and nut 32 is shown.

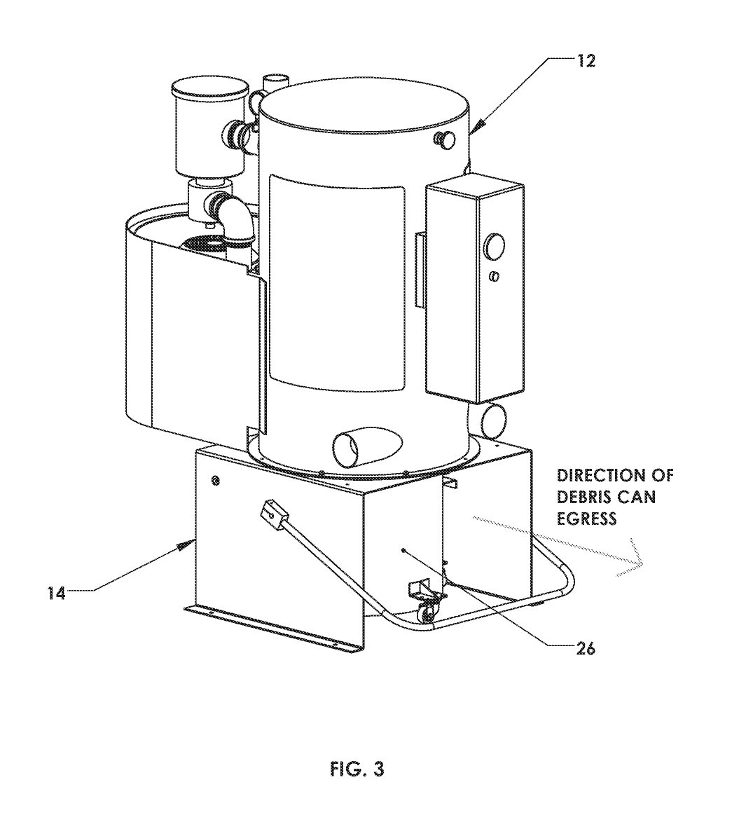

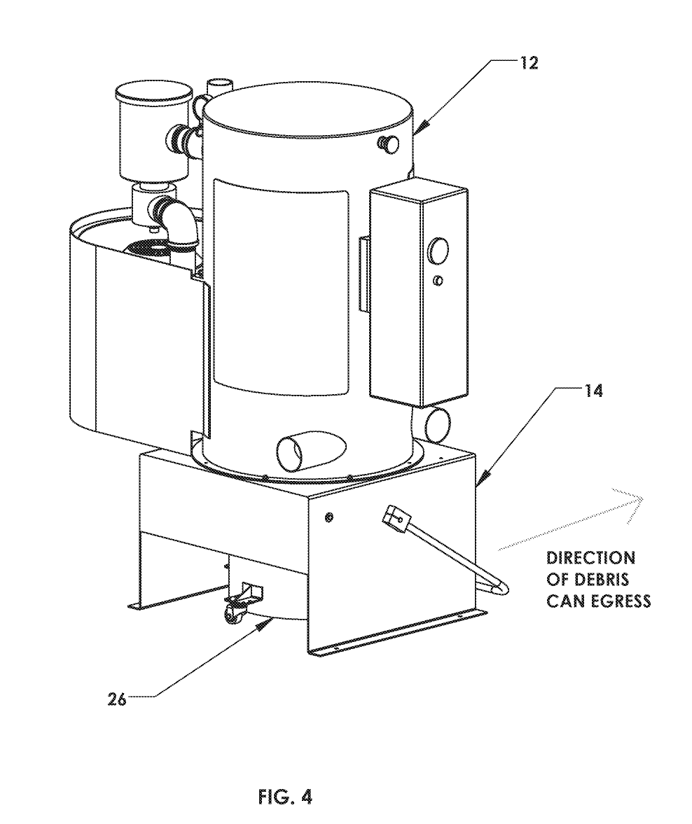

In the embodiment shown in FIG. 2 (and FIGS. 1, 3-5), the canister assembly 12 attaches to the base assembly 14 by 8 bolts that feed through holes that are equidistantly spaced apart from each other around the circumference of the flange 28, the seal ring 30, and the base assembly 14. In this particular configuration, the base assembly 14 can be rotated in 45-degree increments relative to the filter canister assembly 12 to allow the direction of egress of the debris can to be correspondingly rotated in the 45-degree increments. FIG. 3 shows an embodiment of the vacuum unit 10 in which the base assembly 14 has been removed from the filter canister assembly 12, rotated 90 degrees counter clockwise relative to the orientation shown in FIG. 1, and reconnected to the filter canister assembly 12. Accordingly, the direction of debris can egress has been rotated 90 degrees in the vacuum unit shown in FIG. 3 relative to the orientation shown in FIG. 1. Likewise, FIG. 4 shows an embodiment of the vacuum unit 10 in which the base assembly 14 has been removed from the filter canister assembly 12, rotated 180 degrees clockwise relative to the orientation shown in FIG. 1, and reconnected to the filter canister assembly 12. Accordingly, the direction of debris can egress has been rotated 180 degrees in the vacuum unit shown in FIG. 4 relative to the orientation shown in FIG. 1.

While the vacuum unit embodiment shown in FIGS. 1-5 illustrates a configuration in which the base assembly 14 can be rotated relative to the filter canister assembly 12 in 45-degree increments, this embodiment does not limit or restrict the possible means or configurations of attachment of the filter canister assembly 12 to the base assembly 16. Accordingly, the filter canister assembly 12 can be attached to the base assembly 14 not only by bolts but by any other fastening means that allow the base assembly 14 to be removed, rotated, and reconnected to the filter canister assembly 12. Likewise, the means of attachment of the filter canister assembly 12 to the base assembly 14 can be configured to allow any range of rotation increments in the flange 28 of the filter canister assembly 12, thereby allowing rotation of the direction of egress of the debris can 26 to any range of rotation increments in possible directions of egress of the debris can 26. While the base assembly 16 and debris can 26 are rotatable throughout a 360-degree circle of possible directions of egress of the debris can 26, in practice the debris can 26 direction of egress preferably would not be under the vacuum producer 16.

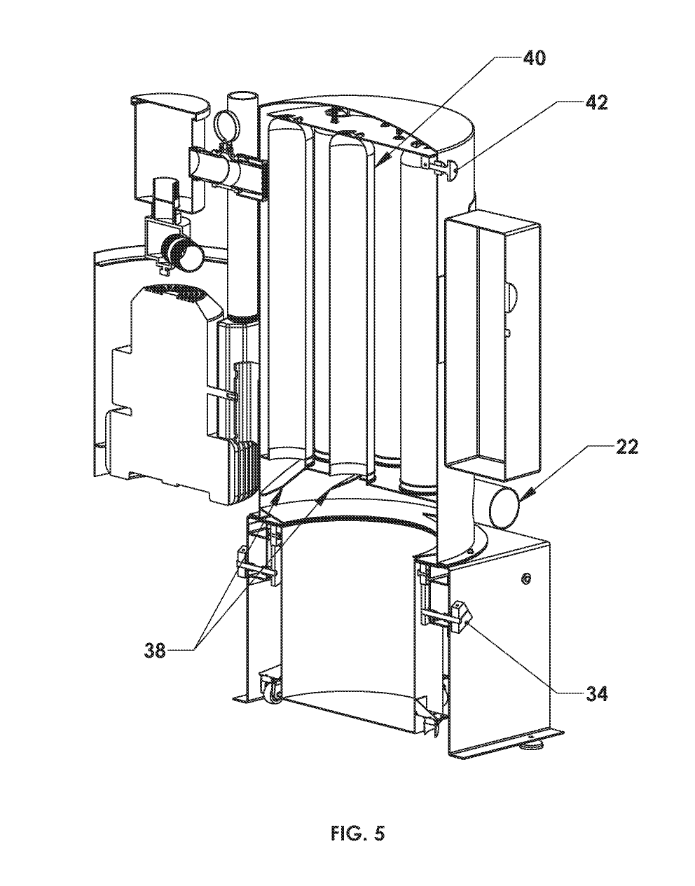

The debris can 26 is removably attached to the base assembly 14. In one embodiment, a pivotally movable bail 34 that lies across the opening of the base assembly 14 operates a cam mechanism for raising and lowering the debris can 26. In operation, debris from the vacuum air stream in the vacuum unit 10 enters the separator assembly through a vacuum inlet 22. The vacuum stream is directed toward one or more striker plates or deflectors (38), which are shown in FIG. 5. When large and/or heavy debris contacts a striker plate (38), the debris falls into the debris can 26. Finer particulate debris in the vacuum stream is removed as the vacuum stream flows through inverted filters 40 in the filter canister assembly 12. When the vacuum is not in operation, debris from the filters 40 can be shaken loose by a bag shaker and deposited into the debris can 26 for removal. In one embodiment, the bag shaker can be a manually operated shaker that is manually moved by a handle 42 located on the outside of the filter canister assembly.

The filter canister assembly 12 includes a bag chamber containing inverted filters 40. Access to the bag chamber is provided by relatively large access doors 24 on the filter canister assembly 12 to facilitate filter bag inspection and replacement, as may be necessary. In the presently disclosed embodiment of FIGS. 1-4, the filter canister assembly 12 has two access doors 24 to provide greater versatility of installation of the vacuum unit 10. In the event that a particular installation provides limited space and corresponding limited space for opening one of the access doors 24, the other door 24 may be accessible, thereby allowing installation of the vacuum unit 10 without blocking access to the interior of the filter canister assembly.

The presently disclosed filter canister assembly 12 includes two vacuum inlets 22. The inclusion of a second vacuum inlet allows for increased configurations for attaching vacuum tubing to the vacuum unit compared to a single vacuum inlet as often typically found in most vacuum units. The two vacuum inlets 22 on the filter canister assembly 12 therefore contribute to the versatility of installation locations of the presently disclosed vacuum unit.

The design of the removable base assembly depicted in the presently disclosed vacuum unit allows the vacuum unit to be adaptable for installation in spaces that may be limited, particularly with respect to being able to access and remove the debris can. The benefit of being able to orient the base assembly relative to the filter canister assembly is to allow changing of the orientation of the direction of egress of the debris can. Accordingly, the presently disclosed vacuum unit can be adapted on site for different installations that may require different directions of egress of the debris can.

The versatility of potential configurations of the presently disclosed vacuum unit is further enhanced by including two access doors on the filter canister assembly and two, alternative vacuum inlets. These features may allow for installation into tight or limited spaces that otherwise might not be achievable or practical with just a single access door and/or a single vacuum inlet. The versatility of the adaptable vacuum unit is also enhanced by the canister mounted vacuum producer, which decreases the size of the area required for the vacuum unit compared to a unit that has a vacuum producer mounted independently of the canister assembly. The installation of the unit is eased and facilitated by lifting lugs around the top edge of the canister, and slots in the base of the unit. These features respectively facilitate handling of the unit with an overhead lifting device and a fork lift, thereby minimizing equipment and manpower required to move and install the vacuum unit. The versatility of the adaptable vacuum unit is further enhanced by including a variable speed vacuum producer, which allows for adjustable air flow.

The drawings and specifications have set forth preferred embodiments. Although specific terms are employed they are used in a descriptive sense and not for the purpose of limitation.

Having illustrated and described the principles of the invention in a preferred embodiment thereof, it should be readily apparent to those skilled in the art that the invention can be modified in arrangement and detail without departing from such principles. I claim all modifications coming within the spirit and scope of the accompanying claims.

I claim:

1. A vacuum cleaning unit separator assembly comprising:
a filter canister assembly; and
a base assembly rotatably attached to the filter canister assembly, the base assembly having a removable debris can.

2. The vacuum cleaning unit separator assembly of claim 1, further comprising multiple access doors on the filter canister assembly.

3. The vacuum cleaning unit separator assembly of claim 1, further comprising a sealing ring disposed between the filter canister assembly and the base assembly.

4. The vacuum cleaning unit separator assembly of claim 1, further comprising multiple vacuum inlets on the filter canister assembly.

5. The vacuum cleaning unit separator assembly of claim 1, the base assembly having an opening that defines a direction of egress of the debris can from the base assembly, wherein position of the opening and the direction of egress of the debris can is adjustable.

6. The vacuum cleaning unit separator assembly of claim 1, further comprising a debris can lifting and locking bar mounted to the base assembly.

7. An adaptable vacuum cleaning unit comprising:
a separator assembly having a filter canister assembly and a base assembly rotatably attached to the filter canister assembly;
a debris can removably attached to the base assembly;
multiple access doors on the filter canister assembly; and
multiple vacuum inlets on the filter canister assembly.

8. The adaptable vacuum cleaning unit of claim 7, further comprising lifting lugs mounted to a top edge of the filter canister assembly.

9. The adaptable vacuum cleaning unit of claim 7, further comprising forklift slots in a bottom edge of the base assembly

10. The adaptable vacuum cleaning unit of claim 7, further comprising an adjustable speed vacuum producer.

11. The adaptable vacuum cleaning unit of claim 7, further comprising a vacuum producer mounted on the filter canister assembly.

12. The adaptable vacuum cleaning unit of claim 7, further comprising a sealing ring disposed between the filter canister assembly and the base assembly.

13. The adaptable vacuum cleaning unit of claim 7, the base assembly having an opening that defines a direction of egress of the debris can from the base assembly, wherein position of the opening and the direction of egress of the debris can is adjustable.

14. The adaptable vacuum cleaning unit of claim 7, further comprising a debris can lifting and locking bar mounted to the base assembly.

15. An adaptable vacuum cleaning unit comprising:
a separator assembly having a filter canister assembly and a base assembly rotatably attached to the filter canister assembly;
a debris can removably attached to the base assembly; and
the base assembly having an opening that defines a direction of egress of the debris can from the base assembly, wherein the direction of egress of the debris can is adjustable.

16. The adaptable vacuum cleaning unit of claim 15, further comprising multiple access doors on the filter canister assembly.

17. The adaptable vacuum cleaning unit of claim 15, further comprising multiple vacuum inlets on the filter canister assembly.

18. The adaptable vacuum cleaning unit of claim 15, further comprising a vacuum producer mounted on the filter canister assembly.

19. The adaptable vacuum cleaning unit of claim 15, further comprising lifting lugs mounted to a top edge of the filter canister assembly.

20. The adaptable vacuum cleaning unit of claim 15, further comprising forklift slots in a bottom edge of the base assembly.
